(19) United States
(12) Patent Application Publication
(10) Pub. No.: US 2007/0055736 A1
(43) Pub. Date: Mar. 8, 2007

(54) System for exchanging messages

(76) Inventor: Milan Ilic, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/570,513

(22) PCT Filed: Jul. 15, 2004
(86) PCT No.: PCT/EP04/07885

§ 371 Date: Nov. 17, 2006

(30) Foreign Application Priority Data
Sep. 1, 2003 (AT) A 1371/2003

(51) Int. Cl. G06F 15/16

(52) U.S. Cl. 709/207; 709/203

(57) ABSTRACT

Disclosed is an instant messaging-based management system that comprises a number of terminals which can be connected to a telecommunications network and in which one respective user interface is provided for generating or processing instant messages of a telecommunication network. A central point is equipped similar to a terminal, encompassing a user interface and a central application that is set up thereupon so as to manage specific data of other system terminals, that management activity including an exchange of messages containing and/or requesting data that is to be managed by means of the instant messaging service.

### CROSS REFERENCE TO RELATED APPLICATION

This application is the US National Stage of International Application No. PCT/EP2004/007885, filed Jul. 15, 2004 and claims the benefit thereof. The International Application claims the benefits of Austrian Patent application No. A 1371/2003 filed Sep. 01, 2003, both of the applications are incorporated by reference herein in their entirety.

### FIELD OF THE INVENTION

The invention relates to a system for exchanging messages using an instant messaging service, with a number of terminals which can be connected to a telecommunication network, in which in each case one user interface is provided for generating and transmitting and/or for receiving and processing instant messaging messages of an instant messaging service supported by the telecommunication network. The invention similarly relates to the terminals for implementing this system.

### BACKGROUND OF THE INVENTION

The term “instant messaging” (abbreviated below to “IM”) refers to services based on the internet, and more precisely to protocols of the internet, in particular the IP protocol, which allow the rapid exchange of messages. The term (“instant messaging system”) originates herefrom. The messages exchanged here are generally short texts which are exchanged between each two users.

Known examples of IM services are chat services on the internet, the SMS service of the GSM mobile radio network and the IM service of the GPRS network. More specific information about the IM can be learned from the book “Instant Messaging Systems: Cracking the Code”, Dreamtech Software Team, Wiley 2002, ISBN 0-7645-4953-7, Chapter 1 in particular.

FIG. 1 shows the architecture of a typically known IM implementation. The terminals E1, E2, E3 of a number of users are connected to the internet IPN, and in each case via a connection (using base stations BS) realized with the aid of a known telecommunication network. The relevant communication network in each instance can be a GPRS network or another mobile radio network for instance. IM messages can be exchanged between the terminals. An IM server ISV is set up in the internet for this purpose, said IM server ISV switching the IM messages between the individual terminals E1-E3. The IM server ISB additionally manages personal contact lists for the IM user as well as the so-called “Presence” of the IM terminals, under which the localization of a terminal (in particular a not constantly active terminal and/or mobile terminal) in a network and the identification of its presence, is deemed possible. The IM-specific data of the user and the contact lists are retained on a database ISD assigned to the IM server ISV.

In the known systems, the installation of a new function into an existing IM system and likewise the extension of an existing function is difficult as the central server application must be installed on the IM server of the IM system. This requires access to the IM system, which the operators thereof naturally do not freely allow, and increases the risk of influencing the performance of the IM service itself.

### SUMMARY OF THE INVENTION

The object of the invention is to eliminate the difficulties involved with the installation of new IM applications, and to indicate a way of implementing IM-based message exchange systems without exerting an influence on an existing IM system.

This object is achieved based on a system of the type mentioned at the outset by a system with at least one terminal device set up as a “central point”, with a user interface and a central application that is set up thereupon so as to manage specific data of other system terminals—the “terminal points”—and including an exchange of messages with the terminal points, carried out using the instant messaging service, said messages containing and/or requesting data that is to be managed.

The solution according to the invention solves the object in a simple and efficient manner. An additional application layer is applied over the known client server architecture, in which application layer one (or a few) selected terminals are set up as application servers for the remaining terminals participating in the system. This gives rise to an architecture independent of the underlying IM system, said architecture being able to use the services of the IM system without having to modify them.

In a preferred embodiment of the invention, the telecommunication network, or at least one of the networks used therein, is a mobile radio network, in which an instant messaging service is supported. It is likewise favorable for the telecommunication network, or at least one of the networks used therein, to be an IP-based computer network, in particular the internet.

An advantageous development of the invention allows a message exchange matched to the application, with the central point for controlling a message exchange being carried out using the instant messaging service being set up between the terminal points and the terminal points being set up in order to exchange information with other terminal points by means of instant messaging messages, which are exchanged with the at least one central point.

A device for use as a central point in a system according to the invention is particularly suited to the invention, having a user interface and a central application that is set up thereupon so as to manage specific data of terminal points, including an exchange of messages with the terminal points, carried out using the instant messaging service, said messages containing and/or requesting data that is to be managed.

For the purpose of simplifying and improving the handling of the system, it is advantageous for the central application for managing terminal points-specific data of the terminal points including the receipt of this data to be set up in form of instant messaging messages. A database for managing the terminal points-specific data can be provided here.

In an advantageous development of the invention (corresponding to the above), the central application of the central point can be set up so as to control a message exchange between the terminal points, carried out using the instant message service.

A device for use as a terminal point in a system according to the invention is similarly suited to the invention, having a user interface for generating and transmitting and/or for receiving and processing instant messaging messages of an instant messaging service, which is supported by a telecommunication network, to which the terminals can be connected, with this device being set up to exchange messages with a central point, said messages containing and/or requesting data that is to be managed.

A preferred embodiment of this terminal point device is designed as a mobile terminal of a mobile radio network, in which an instant messaging service is supported.

For the purpose of simplifying the central management of the system, it is favorable for the terminal device to be set up to transmit terminal point-specific data to the central point using instant messaging messages.

In an advantageous development of the invention the terminal point device (corresponding to the above) can be set up to exchange information with other terminal points by means of instant messaging messages, which are exchanged using a central point.

### BRIEF DESCRIPTION OF THE DRAWINGS

The invention together with further advantages is described in more detail below with reference to a non-restrictive exemplary embodiment, namely to a management system based on an IM system, said management system being displayed in the appended drawings, in which

FIG. 1 shows a schematic representation of a known IM architecture

FIG. 2 shows a schematic representation of the architecture of the IM-based management system according to the invention

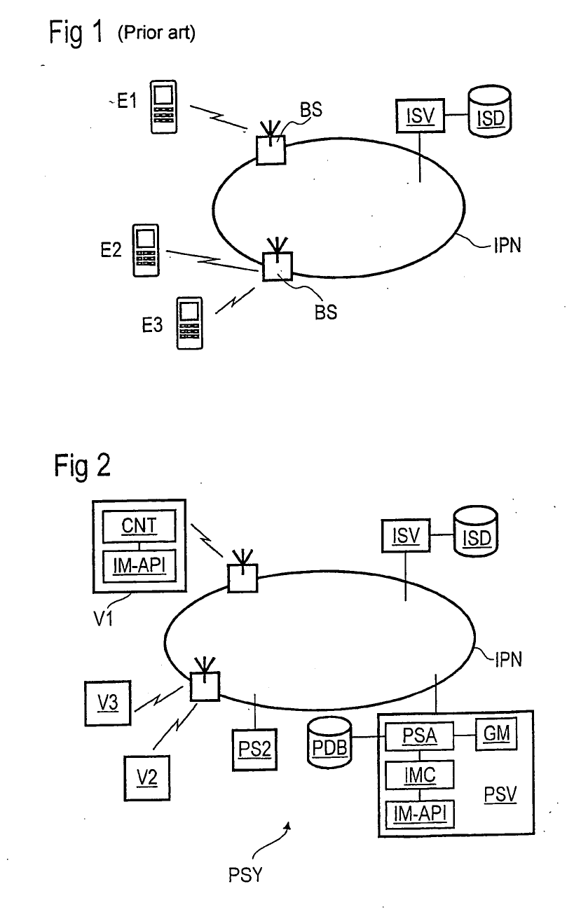

### DETAILED DESCRIPTION OF THE INVENTION

FIG. 2 shows an on-site management system PSY for mobile terminals, for instance the vehicles V1, V2, V3 of a vehicle fleet, which are respectively set up with a terminal device for exchanging messages based on an IM service via the internet and GPRS.

Based on the mobile terminal V1, the essential components of a terminal of the system PSY are described. The communication of the mobile terminal is based on a connection via GPRS or another mobile network to the internet IPN with the aid of an IM user interface IM-API in a manner known per se, and for the purpose of the IM service, the protocols of the internet, in particular IP protocol and TCP protocol and the further layers belonging to the IM service, can be set up on the established GPRS data transmission. The transmitting and receiving of messages is managed by a client application program CNT using the IM interface IM-API. Any other network can be used instead of the internet IPN (or in combination therewith), in which the protocols necessary for an IM service, such as the IP protocol for instance, are supported. An example of such a network is the known GPRS network, in which an IM service is implemented.

An additional application server PSV is provided as a “central point” for the management of the system PSY, in particular of subscriber data of the relevant terminals V1-V3 as “terminal points”, as well as the exchange of messages within the system. The server PSV is connected to the network IPN according to known manner using an IM interface IM-API (which can be identical to the IM interfaces of the terminals), for instance similarly via a mobile interface or preferably via a LAN or another fixed wired connection. An IM client program IMC of a known type serves as a user-side interface for a server application program SVA. The application SVA controls the management of the terminals of the IM system PSY and the handling of the IM messages exchanged therewith. The respectively assigned terminal point-specific data is managed for the terminals (more precisely terminal points), the GPS position of the relevant terminals V1-V3 also belonging here by way of example, in addition to the presence data.

As mentioned above, the server PSV is included as a further client in regard to the IM system or the IM layer (interfaces IM-API). On the layer of the system application programs CNT, SVA, the server PSV is identified as a control center of the system PSY compared with the terminals V1-V3. The system PSY thus uses the IM system as a transparent platform. Thus, with the implementation of the system PSY, no interventions into the present IM implementation are necessary, particularly not into the implementation of the IM server ISV. A simplification of the implementation of the system PSY results, since, on the one hand, the architecture of the IM system and its service offerings are used without modifications and, on the other hand, the control center PSV is implemented as a special client of the IM system. The architecture according to the invention thus represents an efficient alternative solution for the known client server architecture.

The IM interfaces IM-API provide the following basic functions:
connect/disconnect with the IM server ISV
transmit and receive IM messages
set and get the presence status
handle incoming messages

The information is exchanged between the terminals and the control center by means of messages using the IM service (system messages). The system messages are implemented as IM messages and are transmitted transparently by the IM service. Additional formatting components in the user data part of the IM messages can be used if necessary for identifying the system messages, as well as for defining the message types or the like.

The terminals V1-V3 are essentially still able to exchange information with one another in the form of IM messages. In an extended version, the transmission of messages in the management system according to the invention can also be provided by way of the control center. In this case a message conforming to the system and exchanged between two terminals, e.g. V1 and V2, of the system PSY is transmitted from transmitter V1 to the central point PSV, received there, and evaluated with regard to the intended recipient (namely V2) and then transmitted from there to the actual recipient V2. The information about which recipient V2 the system message is to be directed to is coded for instance in an additional header, said header being contained in the user data portion of the IM message together with the actual message text.

Further server devices PS2 can also be provided if necessary, in order to achieve a load distribution across a number of server computers for instance. The server devices PSV, PS2 can be set up in a peer to peer manner if the actual application allows this. A hierarchical structure is also conceivable however, in which a number of ‘local’ servers each supply a group of terminals and exchange messages among each another via a central server, in which the central management of the system and subscriber data is also located.

In the example of the onsite management system, the server PSV serves as an onsite information center. The application program CNT regularly, e.g. every 10 minutes, determines the position of the terminal for each terminal, with the aid of a GPS module GM for instance and thus provides a message which is sent to the control center PSV (position notification). On the server side, the server application SVA maintains a position database PDB, in which the positions of the terminals are updated continuously on the basis of the position notifications. The position data of all terminals is made available to the terminals in this manner and can be queried, e.g. by means of a corresponding IM message (query message) at the control center PSV, which responds with an IM message (position message) transmitted to the querying terminal. The time interval for the position notifications can be adjusted by the control center, by means of messages (configuration messages) sent to the terminals for instance, in which messages the new value of the time interval (or another parameter to be changed) is specified.

The system PSY represented relates to the IM service of the GPRS network. The use of the GPRS has the following advantages compared with other networks. A restoration mechanism (so-called ‘re-establishing’) exists in the event of interruptions. The exchange of information is billed according to the extent of the quantity of data actually exchanged (not according to the connection time as with conventional telephone networks or the number of messages as with SMS). GPRS data connections can additionally be suspended. A GPRS end terminal can naturally also be used as a telephone.

1-12. (canceled)

13. A system for exchanging messages using an instant messaging service, comprising:
a number of terminals that are connected to a telecommunication network, in which terminals in each case one user interface is provided for generating and transmitting and/or for receiving and processing instant messaging messages of an instant messaging service supported by the telecommunication network; and
at least one terminal device with a user interface and a central application set up thereupon so as to manage specific data of other terminals, including an exchange of messages with the terminal points, carried out using the instant messaging service, the messages containing and/or requesting data to be managed.

14. The system according to claim 13, wherein the telecommunication network, or at least one of the networks used therein, is a mobile radio network in which an instant messaging service is supported.

15. The system according to claim 13, wherein the telecommunication network, or at least one of the networks used therein is an IP-based computer network.

16. The system according to claim 15, wherein the telecommunication network is the internet.

17. The system according to claim 13, wherein the central point is set up in order to control an exchange of messages between the terminals and carried out using the instant messaging service with the terminal points being set up to carry out an information exchange with other terminal points by means of instant messaging messages, which are exchanged with the at least one control center.

18. A device for use as a central point in a system, comprising:
a number of terminals that are connected to a telecommunication network, in which terminals in each case one user interface is provided for generating and transmitting and/or for receiving and processing instant messaging messages of an instant messaging service supported by the telecommunication network;
at least one terminal device with a user interface and a central application set up thereupon so as to manage specific data of other terminals, including an exchange of messages with the terminal points, carried out using the instant messaging service, the messages containing and/or requesting data to be managed; and
a user interface and a central application set up thereupon so as to manage specific data of terminal points, including an exchange of messages with the terminal points carried out using the instant messaging service, the messages containing and/or requesting data to be managed.

19. The device according to claim 18, wherein the central application is set up so as to manage terminal point-specific data of the terminal points including the receipt of this data in the form of instant messaging messages.

20. The device according to claim 19, wherein a database is provided for managing the terminal point-specific data.

21. A device according to claim 18, wherein the central application is set up to control a message exchange between the terminals using the instant messaging service.

22. A device for use as a terminal point in a system, comprising:
a number of terminals that are connected to a telecommunication network, in which terminals in each case one user interface is provided for generating and transmitting and/or for receiving and processing instant messaging messages of an instant messaging service supported by the telecommunication network; and
at least one terminal device with a user interface and a central application set up thereupon so as to manage specific data of other terminals, including an exchange of messages with the terminal points, carried out using the instant messaging service, the messages containing and/or requesting data to be managed with a user interface for generating and transmitting and/or for receiving and processing instant messaging messages of an instant messaging service, which is supported by a telecommunication network, to which the terminal can be connected,
wherein it is set up to exchange messages with a central point, the messages containing and/or requesting data to be managed.

23. The device according to claim 22, wherein the device is designed as a mobile terminal in a mobile radio network, in which an instant messaging service is supported.

24. The device according to claim 22, wherein the device is set up to transmit terminal point-specific data to the central point using instant messaging messages.

25. The device according to claim 22, wherein the device is set up to carry out an information exchange with other terminal points by means of instant messaging messages which are exchanged with a central point (PSV, PS2).
